(19) United States
(12) Patent Application Publication
(10) Pub. No.: US 2005/0165716 A1
(43) Pub. Date: Jul. 28, 2005

(54) Method for automated connection of multiple processing machines

(75) Inventors: Chih Ying Huang, Hsinchu (TW); Sen Ho Tang, Hsinchu (TW)

Correspondence Address: MARTINE PENILLA & GENCARELLA, LLP, 710 LAKEWAY DRIVE, SUITE 200, SUNNYVALE, CA, 94085, US

(73) Assignee: Macronix International Co., Ltd.

(21) Appl. No.: 10/749,974

(22) Filed: Dec. 30, 2003

(51) Int. Cl. G06F 7/00

(52) U.S. Cl. 707/1

(57) ABSTRACT

A system and method of data communication between processing machines that includes receiving a message produced by a first processing machine at a database server. The message is transmitted via a socket protocol. The message is received in the database server. The received message is analyzed in the database server. The received message is stored when the received message is a processing data. The received message is transformed into a database instruction when the received message is an instruction.

### BACKGROUND OF THE INVENTION

1. Field of the Invention

The present invention relates generally to data communication systems and, more particularly, to methods and systems for transferring data between two processing machines.

2. Description of the Related Art

Data systems including a server (e.g., a database server) and multiple client machines have become very commonplace and used for a wide variety of purposes. FIG. 1 shows a typical example of a data system 100. The data system 100 includes a server 102, and multiple client machines 104A-n. The server 102 is coupled to the client machines 104A-n via interconnecting network system 106.

Prior art data systems typically use a network file system (NFS) 112 to store files in the server 102. The client machines 104A-n create corresponding data files 108A-n in real time as the data are produced in the respective client machines. However, these data files 108A-n cannot be stored in the server 102 at the same time (i.e., near real time or real time) as the data files are created as will be described in more detail below.

Prior art data systems (e.g., data system 100) require some sort of communication application layer 110 to communicate between the client machines 104A-n and the server 102. Precise access-type commands (e.g., a store command) must also be input to the server 102 to access the server. The communication application 110 delays the delivery of the data files 108A-n to the database server 102. By way of example, the communication application software 110 formats the data files 108A-n and inserts the appropriate access type commands that allow the network file system 112 to access the server 102 so as to store the data files on the server.

The resulting delay can cause unnecessary delay in subsequent processing of data. By way of example, each of the client machines 104A-n can be processing data that requires a response from the server 102 to continue or complete the data processing. Further, each of the client machines 104A-n can be a different type of computer or other networked machine (e.g., DOS, Unix, Solaris, etc.) and therefore the communication application software 110 must process the data from each client in a different manner which can further delay the data files' arrival in the server 102.

In view of the foregoing, there is a need for a system and a method for enabling near real time data delivery from client machines to a server.

### SUMMARY OF THE INVENTION

Broadly speaking, the present invention fills these needs by providing an improved data communication system and method between two or more processing machines. It should be appreciated that the present invention can be implemented in numerous ways, including as a process, an apparatus, a system, computer readable media, or a device. Several inventive embodiments of the present invention are described below.

One embodiment includes a method of data communication between processing machines that includes transmitting a message produced by a first processing machine to a database server. The message is transmitted via a socket protocol. A TCP/IP protocol can also be used. The message is received in the database server. The received message is analyzed in the database server. The received message is stored when the received message is a processing data. The received message is transformed into a database instruction when the received message is an instruction. The message produced by the first processing machine is transmitted to the database server as a data included in the message is produced.

Transmitting a message produced by the first processing machine to the database server can include formatting a header of the transmitted message to identify if the message is a database instruction. Analyzing the received message in the database server can include analyzing the header of the message to determine if the message includes the database instruction. Transforming the received message into a database instruction when the received message is the database instruction can include dynamically identifying an SQL instruction.

The method can also include executing the instruction to produce a result. The result can be returned to the first processing machine. The message was produced as a result of processing within the first testing machine and the processing required the result to continue and wherein the first processing machine receives the result set and resumes processing.

The database server can include a daemon. The daemon monitors a predetermined socket for messages from the first processing machine.

Another embodiment includes a system for communicating data between processing machines. The system includes a database server, at least one processing machine capable of communicating with the database server via a socket protocol and a network for coupling the at least one processing machine to the database server. A TCP/IP protocol can also be used. A daemon can be included within the database server. The daemon being capable of determining if a message received from the at least one processing machine is a database instruction. The daemon is capable of monitoring a predetermined socket for a message from a first processing machine of the at least one processing machines.

Each of the at least one processing machine includes a corresponding operating system. The corresponding operating systems can be different for each of the at least one processing machine.

A header of the received message can include an identification of the message as including a database instruction. The daemon can include a dynamic language compiling technology. The dynamic language compiling technology can include an SQL language compiling technology that includes the capability of converting the message to an SQL instruction.

Another embodiment includes a method for data communication between processing machines. The method includes transmitting a message produced by a first processing machine to a database server. The message being transmitted via TCP/IP protocol and socket protocol. A header of the message being formatted to identify message as a database instruction, if the message is a database instruction. The message is received in the database server. The header of the received message in a daemon in the database server. The received message is stored when the received message is a processing data. The received message is transformed into an SQL instruction when the received message is an instruction. The instruction is executed to produce a result and the result is returned to the first processing machine.

The daemon monitors a predetermined socket for messages from the first processing machine. The message is transmitted to the database server as the data included in the message is produced in the first processing machine.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a typical example of a data system.

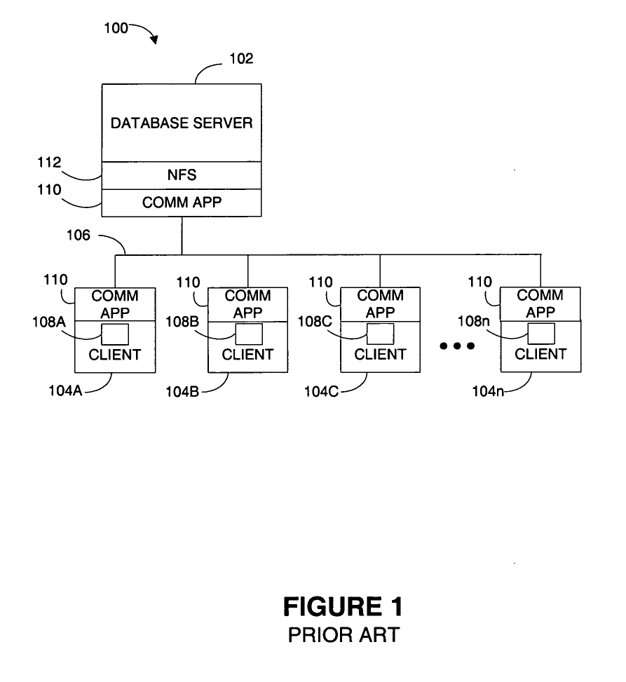

FIG. 2 shows a test development system (TDS) in accordance with one embodiment of the present invention.

FIG. 3 is a flowchart of the method operations when the daemon receives a message from the socket, in accordance with one embodiment of the present invention.

### DETAILED DESCRIPTION OF THE EXEMPLARY EMBODIMENTS

Several exemplary embodiments for an improved data transmission method will now be described. It will be apparent to those skilled in the art that the present invention may be practiced without some or all of the specific details set forth herein.

In one embodiment, the present invention employs TCP/IP and socket technology to transmit data between a database server (DB server) and one or more client machines. The client machines transmit data produced by processing processes in real time (i.e., as the data are produced) to the DB server. One embodiment of the present invention includes a daemon in the DB server. The daemon monitors (i.e., listens to) TCP/IP protocol message with a predetermined socket port. Dynamic SQL technology can also be employed in the daemon to transform an instruction prototype included in a message from a client machine. The message can be converted to an SQL statement such as may be used to access (e.g., store, retrieve) data in the DB server. The message can also include multiple elements such as operation types, filters or values, or codes representing an SQL command that the DB server can identify.

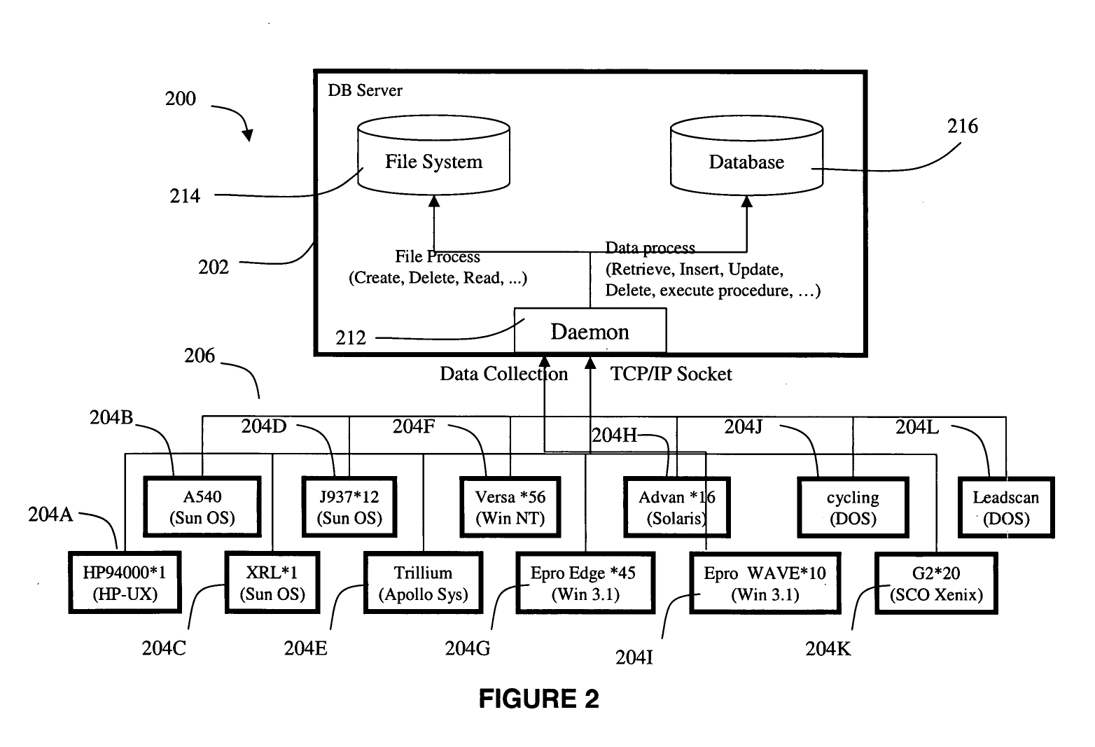

FIG. 2 shows a test development system (TDS) 200 in accordance with one embodiment of the present invention. The TDS 200 includes a DB server 202 that is linked to multiple client machines 204A-L via a network 206. Each of the multiple client machines 204A-L includes a corresponding operation system (e.g., Sun OS 4.1, Apollo Sys, Win 3.1, NT, Solaris, DOS, etc.), as indicated in FIG. 2.

TCP/IP protocol is employed to transmit data from the client machines 204A-L to the DB server 202 immediately as the data are produced. TCP (Transmission Control Protocol) is one of the main protocols in TCP/IP networks. Whereas the IP protocol deals only with packets, TCP enables two computers to establish a connection and exchange streams of data. TCP guarantees delivery of data and also guarantees that packets will be delivered in the same order in which they were sent.

IP (Internet Protocol) specifies the format of packets (i.e., messages) and the addressing scheme. IP by itself is similar to a postal system in that it allows a packet to be addressed and dropped into a network, but there's no direct link between the source of the packet and the intended recipient. TCP/IP, on the other hand, establishes a connection between the source computer and the intended recipient computer so that they can send messages back and forth for a period of time.

Socket technology is a software object. By way of example, in UNIX and some other operating systems, a software object that connects an application to a network protocol. In UNIX, for example, a software application can send and receive TCP/IP messages by opening a socket and reading and writing data to and from the socket. The socket simplifies software application development because the programmer need only worry about manipulating the socket and can rely on the operating system to actually transport messages across the network correctly.

Each of the client machines 204A-L is coupled to the DB server 202 using TCP/IP socket protocol. The client machines 204A-L perform testing procedures. By way of example, a particular software application under test can be tested on each of the client machines 204A-L to confirm functionality and compatibility between the client machines and the software application under test. As the testing is completed in each of the client machines 204A-L, each of the client machines generates one or more testing result files (i.e., messages). The messages are sent to the DB server 202 as they are created.

A daemon 212 can also be included in the DB server 202. The daemon 212 listens to a socket that was previously determined to be used as a communication port to the client machines 204A-L. The daemon 212 reviews the header information included in each message to determine the type of the message. The message can be for example, data to be stored in the DB server 202 or a command to the DB server for processing the message. The commands can include file create, delete, read, and other common database server type commands such as SQL commands. If the command is an SQL command, the DB server 202 will be instructed to perform the identified SQL processing (e.g., insert, delete, update, retrieve data, and execute). After executing the SQL command, the result (or result set) can be immediately returned to the client machine that the message originated from so that the client machine can continue processing it's testing procedures.

As described above, the daemon 212 includes the capability to handle file transferring and identifying a command (e.g., an SQL command) in the receiving of messages. The daemon 212 can also return more messages between file transfer, and perform checksum calculations when a file transfer is completed. When the daemon 212 executes a command (e.g., an SQL command), the daemon returns the result set of the execution.

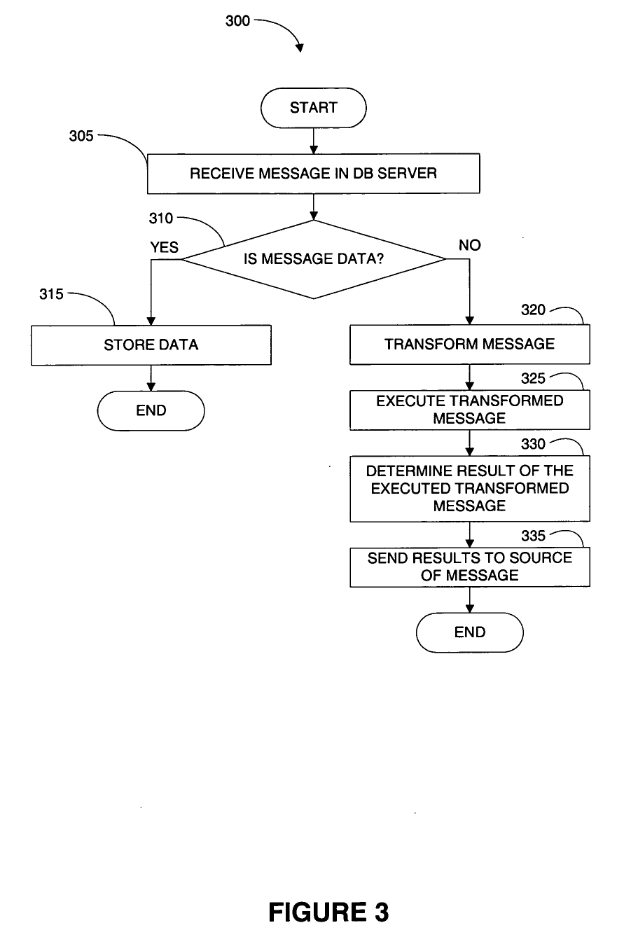

FIG. 3 is a flowchart of the method operations 300 when the daemon 212 receives a message from the predetermined socket, in accordance with one embodiment of the present invention. In operation 305, a message is received in the daemon 212 from one of the client machines 204A-L (e.g., machine 204A). In operation 310 the received message is analyzed to determine if the message includes data. In one embodiment, the message header can be encoded to include the type of message and therefore the message header can be analyzed to determine the type of message. If the received message includes data, then in operation 315, the data is stored into a corresponding part of the DB server 202 (e.g., file system 214).

In the alternative, if in operation 310, the message does not include data, then the message indicates a control command. An exemplary control command can be an accessing command, such as database accessing commands.

In operation 320, a dynamic language compiling technology transforms the received message to a database instruction. Dynamic language compiling technology is well known in the art. An exemplary dynamic language compiling technology is dynamic SQL (structured query language) technology. As a result, commands (i.e., instructions) transmitted by the client machines 204A-L can be simplified by only transmitting numbers indicating the command or transmitting a prototype comprised of multiple elements, such as operation type, values, or filters. In operation 325, the processed message is applied to the DB server 202 to perform the defined command.

In an operation 330, the result (or result set) of the executed database command is determined. In operation 335, the result is output to the source (e.g., client machine 204A) of the received message so that the client machine 204A can use the result. By way of example, the client machines 204A can be processing data that requires a response from the DB server 202 to continue or complete the data processing. Client machine 204A sends a message to the DB server 202 in real time. While client machine 204A is waiting for the required data from the DB server, the processing can stall. As a result, a faster response to the message provides a shorter period that the client machine 204A is stalled.

The message includes a database access command to retrieve the required data. The DB server 202 analyzes the message to identify the message as a database access command (i.e., retrieve command) and performs the specified access operation (i.e. retrieves the data specified in the message). The DB server 202 sends the results of the access to client machine 204A so that the client machine can resume processing.

The present invention uses TCP/IP protocol and socket technology as a communication method between the client machines 204A-L and DB server 202. As a result, the data produced by the client machines 204A-L can be transmitted to the DB server 202 in real time, or substantially real time.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data that can thereafter be read by a computer system. The computer readable medium can also be distributed over a network coupled computer systems so that the computer readable code is stored and executed in a distributed fashion.

It will be further appreciated that the instructions represented by the operations in FIG. 3 are not required to be performed in the order illustrated, and that all the processing represented by the operations may not be necessary to practice the invention. Further, the processes described in FIG. 3 can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for data communication between processing machines, comprising:
receiving a message produced by a first processing machine at a database server, the message being transmitted via socket protocol;
analyzing the received message in the database server;
storing the received message when the received message is processing data; and
transforming the received message into a database instruction when the received message is an instruction.

2. The method of claim 1, wherein the message produced by the first processing machine includes a header formatted to identify whether the message is a database instruction.

3. The method of claim 2, wherein analyzing the received message in the database server includes analyzing the header of the message to determine if the message includes the database instruction.

4. The method of claim 1, wherein transforming the received message into a database instruction when the received message is the database instruction includes dynamically identifying an SQL instruction.

5. The method of claim 1, further comprising executing the instruction to produce a result.

6. The method of claim 5, further comprising:
sending the result to the first processing machine.

7. The method of claim 6, wherein the message was produced as a result of processing within the first testing machine and the processing required the result to continue, and wherein the first processing machine receives the result set and resumes processing.

8. The method of claim 1, wherein the database server includes processing by a daemon.

9. The method of claim 8, wherein the daemon monitors a predetermined socket for messages from the first processing machine.

10. The method of claim 1, wherein the message produced by the first processing machine is transmitted to the database server as data included in the message that is produced.

11. The method of claim 1, wherein the message being transmitted via socket protocol includes being transmitted via TCP/IP protocol.

12. A system for communicating data between processing machines comprising:
a database server;
at least one processing machine capable of communicating with the database server via a socket protocol;
a network for coupling the at least one processing machine to the database server; and
a daemon included within the database server, the daemon capable of determining if a message received from the at least one processing machine is a database instruction.

13. The system of claim 12, wherein the daemon is capable of monitoring a predetermined socket for the message from a first processing machine of the at least one processing machines.

14. The system of claim 12, wherein each of the at least one processing machine includes a corresponding operating system.

15. The system of claim 14, wherein the corresponding operating systems can be different for different processing machines, wherein the at least one processing machine is one of the different processing machines.

16. The system of claim 12, wherein a header of the received message includes an identification of the message as including the database instruction.

17. The system of claim 16, wherein the daemon executes dynamic language compiling.

18. The system of claim 17, wherein the dynamic language compiling includes SQL language compiling that has the capability of converting the message to an SQL instruction.

19. The system of claim 12, wherein the at least one processing machine is capable of communicating with the database server via a TCP/IP protocol.

20. A method for data communication between processing machines, comprising:
receiving a message produced by a first processing machine at a database server, the message being transmitted via TCP/IP protocol and socket protocol, a header of the message being formatted to identify message as a database instruction, if the message is a database instruction;
analyzing the header of the received message through dynamic language compiling at the database server;
storing the received message when the received message is processing data;
transforming the received message into an SQL instruction when the received message is an instruction;
executing the instruction to produce a result; and
sending the result to the first processing machine.

21. The method of claim 20, wherein the dynamic language compiling monitors a predetermined socket for messages from the first processing machine.

22. The method of claim 20, wherein the message is transmitted to the database server as the data included in the message is produced in the first processing machine.
